(19) United States
(12) Patent Application Publication
(10) Pub. No.: US 2018/0192572 A1
(43) Pub. Date: Jul. 12, 2018

(54) Conversion Unit for Indirect Connection of a Mounted Implement to a Working Machine and Enabling Angular Adjustment and Swivelling of Same

(71) Applicant: Jonathan S. Loewen, Ste. Anne (CA)

(72) Inventor: Jonathan S. Loewen, Ste. Anne (CA)

(21) Appl. No.: 15/865,538

(22) Filed: Jan. 9, 2018

Related U.S. Application Data
(60) Provisional application No. 62/444,057, filed on Jan. 9, 2017.

(51) Int. Cl. A01B 59/00; A01B 59/06; A01B 63/02

(52) U.S. Cl. CPC A01B 59/002; A01B 63/02; A01B 59/066

(57) ABSTRACT

A conversion unit is used for indirect attachment of a mounted implement to a working machine. The mounted implement features a single-point connector, while the conversion unit features both a multi-point mounting arrangement configured for removable coupling to a multi-point attachment arrangement on the working machine, and a single-point coupler configured for removable coupling to the single-point connector of the mounted implement. With the conversion unit in an operating position attached to the attachment arrangement of the working machine, coupling of the mounted implement to the conversion unit via engagement of the single-point coupler with the single-point connector indirectly attaches the mounted implement to the working machine in a mounted position thereon. A shared upright axis of the single-point coupler and single-point connector allows angular adjustment or free-swiveling of the implement about the shared axis when a corresponding lock pin is withdrawn from locking position that blocks such movement.

### CROSS-REFERENCE TO RELATED APPLICATIONS

This application claims benefit under 35 U.S.C. 119(e) of U.S. Provisional Application No. 62/444,057, filed Jan. 9, 2017, the entirety of which is incorporated herein by reference.

### FIELD OF THE INVENTION

The present invention relates generally to mounting of implements to tractors and other working machines.

### BACKGROUND

In the field of agricultural machinery, different categories of machine are characterized by the manner in which they are supported and conveyed over the ground. Implements that rely on a tractor as a source of propulsion are divided into three general categories, namely mounted implements, semi-mounted implements and trailed implements. A mounted implement refers to an implement that is supported entirely by the tractor, typically by way of a three-point hitch found thereon, when the implement is in a raised or transport position in which the earth-working tools of the implement are raised out of engagement with the ground. A semi-mounted implement has its front end supported by the tractor, e.g. by the three-point hitch, while a generally horizontal pivot axis allows the rear end of the implement to rise and fall relative to the hitch connection on a set of ground wheels that rollingly support the rear end. This is particularly useful for large or heavy implements, where cantilevered support off the rear of the tractor without dedicated ground wheels on the implement would create excessive loading on the tractor, and introduce stability issues to the overall combination of connected equipment. A trailed implement has a single hitch point and its own dedicated set of ground wheels, and is never fully supported by the tractor itself. Self-propelled machines are those which incorporate a dedicated prime mover for propulsion, and don't rely on a tractor or other vehicle for conveyance.

The present invention is particularly concerned with mounted implements, which as mentioned above are typically carried by a three point hitch of a tractor. With three discrete points of connection, this type of hitch requires that the tractor operator dismount the tractor and manually connect the tractor hitch to the implement at the three pinned connection points.

In addition, a three point hitch does not allow one to change the working angle of an implement relative to the tractor about an upright axis, unless the implement itself is pre-equipped with its own internal angular adjustment mechanism of some sort.

Hitch conversion units have previously been proposed that have a three-point mounting arrangement at a leading end of the unit for connection to the tractor, and a single-point connection arrangement at the trailing end to enable connection of implements with a single-point pin-based connection type. Examples of such conversion units can be found in U.S. Pat. Nos. 3,421,779, 3,542,399, 3,856,331, 4,502,706 and 6,612,380. However, these references are only concerned with enabling attachment of a trailed implement with its own ground wheels to the three-point hitch of a tractor, i.e. enabling use of the tractor as a tow vehicle for moving trailed equipment that is typically not associated with tractor use, and thus is not directly compatible with a three-point hitch. This alone does not address the desire for more convenient attachment of mounted implements, nor provide any solutions for angular adjustment.

Accordingly, there remains room for improved solutions concerning attachment of mounted implements, not just in the context of three-point hitches and agricultural tractors, but also in the context of other working machines that may also benefit from such innovation.

### SUMMARY OF THE INVENTION

According to a first aspect of the invention, there is provided, in combination, a mounted implement for a working machine and a conversion unit for indirect attachment of said mounted implement to said working machine in a mounted position fully supported by said working machine, wherein said mounted implement comprises a single-point connector thereon, and said conversion unit comprises a multi-point mounting arrangement configured for removable coupling to a multi-point attachment arrangement on the working machine and a single-point coupler configured for removable coupling to the single-point connector, whereby with the conversion unit in an operating position attached to the attachment arrangement of the working machine, coupling of the mounted implement to the conversion unit via engagement of the single-point coupler with the single-point connector indirectly attaches the mounted implement to the working machine for support in the mounted position.

In one embodiment, the single-point coupler of the conversion unit comprises a hitch jaw closable about a jaw space, and the single-point connector on the mounting implement is a kingpin that stands upright therefrom for receipt of the kingpin in the jaw space with the jaw closed therearound for hanging support of the mounted implement below the hitch jaw in the mounted position of the implement.

Preferably the kingpin comprises a shank of lesser or equal diameter than a jaw space delimited by the hitch jaw in a closed state thereof, an enlargement of greater diameter than said jaw space such that said enlargement blocks axial withdrawal of the kingpin from said hitch jaw in the closed state thereof, and a taper between said shank and said enlargement that matches a corresponding taper on the hitch jaw.

Preferably the enlargement of the kingpin resides above the shank.

In one embodiment, a set of lock holes are disposed circumferentially around the single-point connector or the single-point coupler on a first one of either the conversion unit or the mounted implement, and a lock pin is disposed on a different second one of either the conversion unit or the mounted implement, said lock pin being movable between a locked position engaged in any selected one of said lock holes to block rotation of the mounted implemented relative to said conversion unit about a shared upright axis of said single-point connector and the single-point coupler when said single-point connector and the single-point coupler are engaged, and unlocked released position at least substantially withdrawn from said lock holes to allow said rotation of the mounted implement about said shared axis.

Preferably said lock holes are located on said mounting implement, and said lock pin is disposed on said conversion unit.

Preferably said lock pin is biased into the locking position.

Preferably there is a lock-out mechanism switchable between a lock-out state fully withdrawing the lock pin from the selected one of the lock holes and preventing biased deployment of the lock pin into the locking position to allow free-swiveling of the mounted implement about the shared axis, and a normal state allowing biased deployment of the lock pin into the locking position.

Preferably the lock-out mechanism comprises a lock-out lever that has an operating end and an opposing working end, is pivotally coupled to the lock pin for movement about a pivot axis transverse thereto, and is movable between a lock-out position lying axially of the lock pin with the working end abutted against a stop surface blocking axial displacement of the lock pin, and a normal position lying transversely of the lock pin with the working end withdrawn from contact with the stop surface.

Preferably the lock holes are defined in a base plate of the single-point connector on the implement.

Preferably the hitch jaw comprises a pair of jaw members pivotal toward and away from one another for closing and opening of the hitch jaw, and a release mechanism of said hitch jaw comprises a fork that has two fingers disposed on opposite sides of said hitch jaw at exterior sides of said jaw members and is displaceable back and forth between a jaw-closing position acting against the exterior sides of the jaws to hold the hitch jaw closed and jaw-releasing position allowing said jaw members to open away from one another.

In one embodiment, the release mechanism is a shared release mechanism operable to both release the single-point coupler and withdraw the lock pin from the locked position into the released position.

In such instance, the shared release mechanism preferably comprises a cam carried with said fork for back and forth movement therewith and over which a follower of the lock pin rides during said back and forth movement to transition said lock pin between the locked and released positions.

Preferably said cam resides on said fork.

Preferably the fingers of the fork have angled interior sides that face one another, ride along the exterior sides of the jaw members, and converge toward a closed end of said fork at which said fingers are joined together so that movement of said closed end of said fork toward the hitch jaw gradually forces the jaw members toward one another into the closed state of the hitch jaw.

In one embodiment, the multi-point mounting arrangement on the conversion unit is a three-point arrangement comprising two lower connect points for connection to two lower links of a three-point hitch on the working machine, and an upper connection point for connection to an upper actuator of the of the three point hitch.

According to a second aspect of the invention there is provided, in combination, a mounted implement for a working machine and a hitch device for attachment of said mounted implement to said working machine, said hitch device and said mounted implement respectively having a single-point coupler and a cooperating single-point connector, axes of which coincide to define a shared upright axis when said single-point coupler and said single-point connector are connected together, wherein a set of lock holes are disposed circumferentially around the single-point coupler or said single-point connector, and a lock pin is movable between a locked position engaged in any selected one of said lock holes to block rotation of the mounted implemented relative to said hitch device about the shared upright axis when said single-point coupler and said single-point connector are connected, and released position at least substantially withdrawn from said lock holes to allow said rotation of the mounted implement relative to the hitch device about said shared axis.

In one embodiment, the hitch device comprises a mounting conversion unit by which the mounted implement is indirectly attached to the working machine via a mounting arrangement of said conversion unit that is configured for removable coupling to an existing attachment arrangement on the working machine.

In one embodiment, said lock pin is disposed on said conversion unit and said lock holes are located on said mounted implement.

Preferably the implement is rotatable 360-degrees about said upright axis.

In one embodiment, the single-point connector is a kingpin and the single-point coupler is a hitch jaw.

In one embodiment, the kingpin is mounted on the mounted implement and stands upright therefrom for hanging of the mounted implement below the hitch jaw.

According to a third aspect of the invention, there is provided a method of mounting an implement to a working machine, said method comprising:

on an existing mounted implement having a first multi-point mounting arrangement configured for attachment to an existing attachment arrangement on the working machine, installing a single-point connector;

with a conversion unit having both a single-point coupler and a second multi-point mounting arrangement that is compatible with said existing multi-point attachment arrangement of the working machine, attaching said conversion unit to the working machine by coupling second multi-point mounting arrangement on the conversion unit with said existing multi-point attachment arrangement of the working machine; and

coupling the single-point connector on the mounted implement to the single-point coupler of the conversion unit to thereby attach said mounted implement to the working machine, and supporting the mounted implement entirely by said conversion unit and said working machine.

### BRIEF DESCRIPTION OF THE DRAWINGS

One embodiment of the invention will now be described in conjunction with the accompanying drawings in which:

FIG. 1 is a perspective view of a hitch conversion unit of the present invention, with a three-point mounting arrangement at one end for connection to a three-point tractor hitch, and an openable/closeable jaw at the opposing end for connection to an implement via an upstanding kingpin mounted thereon.

FIG. 2 is an overhead plan view of the hitch conversion unit.

FIG. 3 is a side elevational view of the hitch conversion unit.

FIG. 4 is a front elevational view of the hitch conversion unit.

FIG. 5 is an exploded perspective view of the hitch conversion unit.

FIG. 5A is a perspective view of the upstanding kingpin for installation on a mounted implement to establish compatibility thereof with the hitch conversion unit.

FIG. 5B is a partial close-up of the encircled portion of the hitch conversion unit of FIG. 5.

FIG. 6 is a rear perspective view of the hitch conversion unit and a box blade implement fitted with the upstanding kingpin of FIG. 5A, with the jaw of the hitch conversion unit in an open position for acceptance of the kingpin of the implement.

FIG. 7A is a top plan view of the hitch conversion unit and box blade of FIG. 6 after coupling, with the box blade set and locked at an oblique working angle relative to a travel direction in which the implement is conveyed.

FIG. 7B is a bottom plan view of the hitch conversion unit and box blade of FIG. 7A.

FIG. 8 is a side elevational view of the hitch conversion unit and implement kingpin of FIGS. 7A and 7B with select components of the conversion unit omitted or shown in transparency to reveal internal details thereof, particularly showing how a spring loaded lock pin is biased into a locking position that locks the angle of the implement by blocking rotation thereof around the kingpin.

FIG. 9 is a partial close-up side elevational view of the conversion unit and implement kingpin of FIG. 8, but with the lock-pin locked-out of the locking position to allow the implement to freely swivel around the kingpin

FIG. 10 is a partial close-up side elevational view of the conversion unit and box blade of FIG. 8, but with a release mechanism moved from its default state of FIG. 8 to a first release stage forcing the spring-loaded lock pin upward into an indexing position.

FIG. 11 is a side elevational view of the conversion unit and box blade of FIG. 10, but with the release mechanism moved onward to a second release stage opening the jaws to release the kingpin of the implement to allow detachment thereof.

FIG. 12 is a partial overhead plan view of the conversion unit and box blade of FIG. 11 during withdrawal of the open jaws of the hitch conversion unit from the kingpin in order to detach the implement.

FIGS. 13A and 13B illustrate the implement at varying angles to the travel direction, as enabled by locking-out or release of the lock pin.

FIG. 14 is a perspective side view of an alternative embodiment of the cooperating hitch conversion unit and implement.

FIG. 15 is a perspective side view of another alternative embodiment of the cooperating hitch conversion unit and implement.

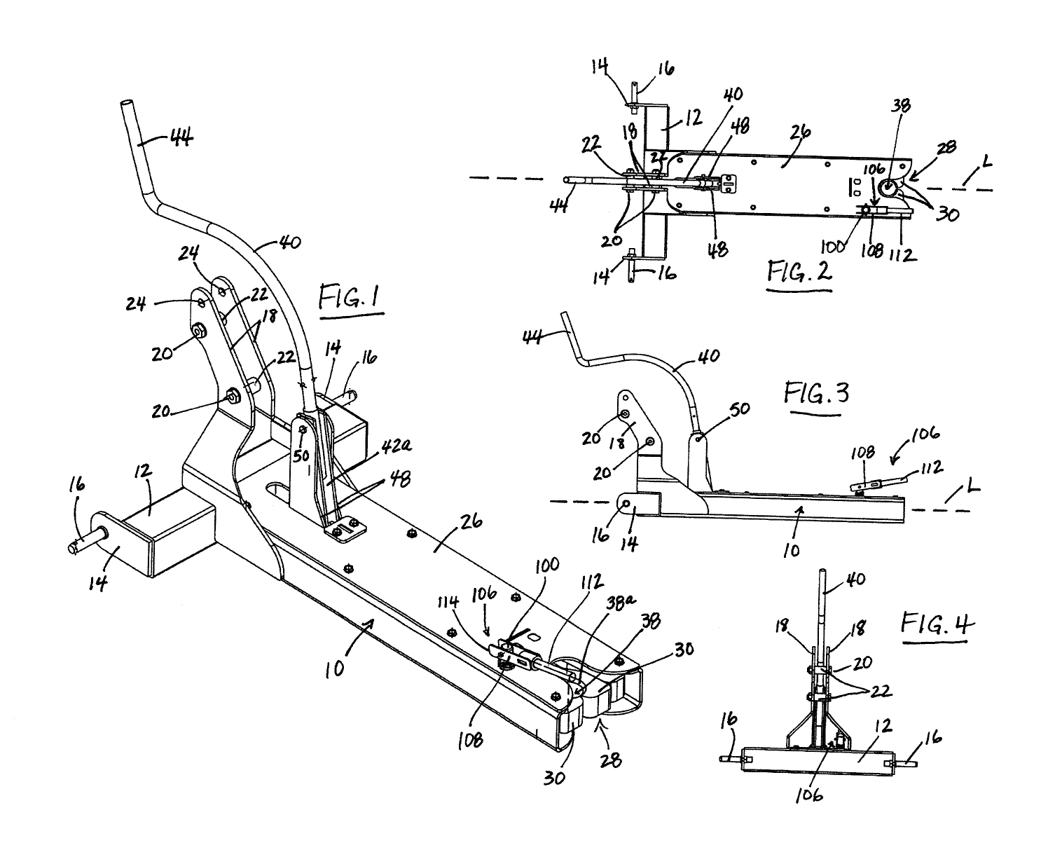

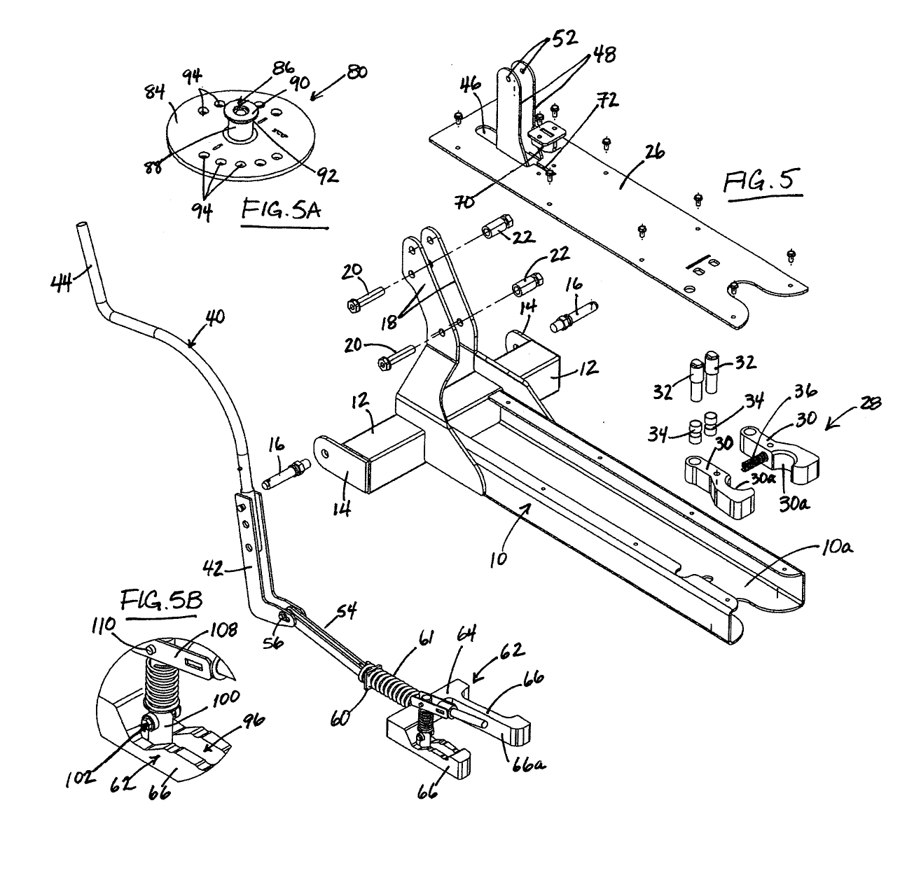

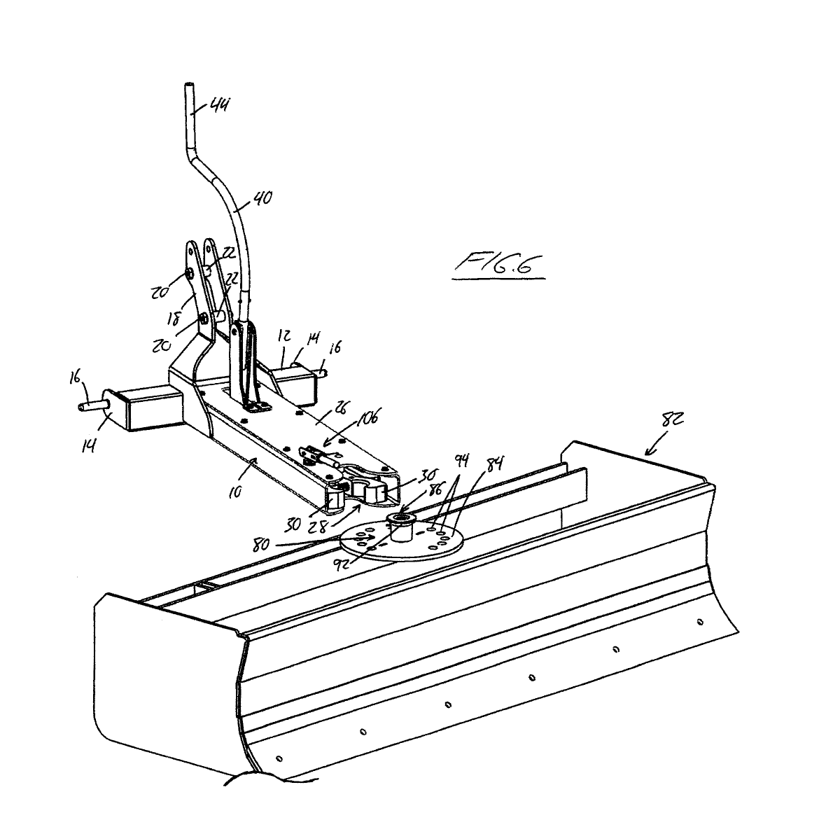

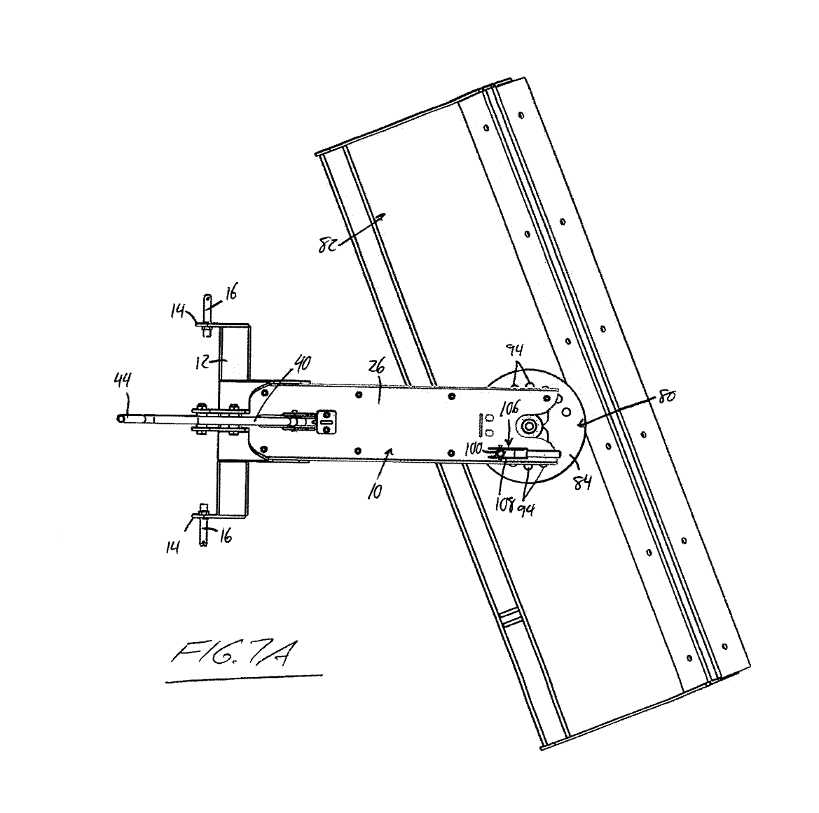

In the drawings like characters of reference indicate corresponding parts in the different figures.

### DETAILED DESCRIPTION

FIG. 1 illustrates a hitch conversion unit according to one embodiment of the present invention. The unit features an elongated housing 10 having opposing front and rear ends spaced apart along a longitudinal axis L. A cross member 12, for example in the form of a length of rectangular tubing, spans perpendicularly across the elongated housing 10 at the front end thereof to reach laterally outward to both sides thereof. At each end of the cross member 12, a respective lug 14 juts forwardly therefrom, and a respective mounting pin 16 juts laterally outward from the lug in parallel relation to the cross member 12. A pair of uprights 18 stand upwardly from the front end of the elongated housing. Upper portions of the uprights stand in parallel relation to one another at a spaced apart distance maintained by two sets of bolts 20 and spacers 22 that horizontally fasten the uprights together above the elongated housing. A pair of aligned holes 24 in the upper portions of the uprights near the top ends thereof enable pinned connection of the top actuator of a conventional three point hitch to the uprights, while the mounting pins 16 at opposing ends of the cross member 12 accommodate connection of the two lower links of the three point hitch thereto. Accordingly, the front end is configured for coupling to a three point hitch of a tractor, the details are of which are well known in the art, and thus not further defined herein.

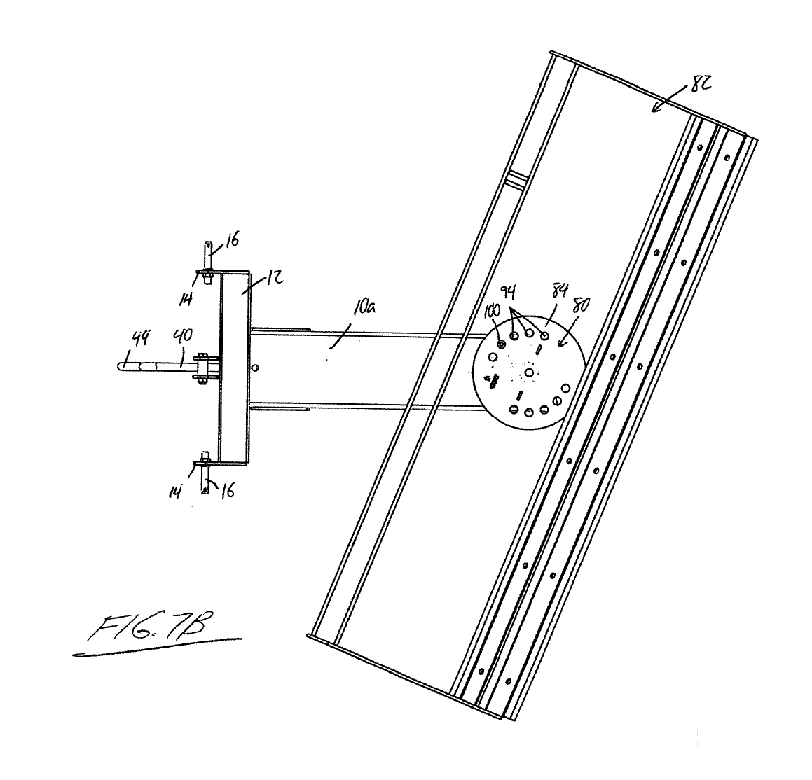

The housing 10 is made up of a length of metal channel having a hollow interior and an open topside, which in the assembled state of the conversion unit shown in FIG. 1 is closed off by cover plate 26. With reference to FIGS. 1 and 5, the housing 10 carries an openable/closeable hitch jaw 28 near the rear end of the housing. The hitch jaw is made up of two movable jaw members 30, each of which is pivotally supported inside the hollow interior of the housing by a respective pivot pin 32 that spans perpendicularly through the bottom wall 10a and opposing top cover plate 26 of the housing via a respective bushing 34 inserted in the jaw member 30 at a mounting end thereof. From their pivotally pinned mounting ends, the jaw members 30 reach toward the rear end of the housing 10, and feature respective concave recesses 30a on facing-together inner sides of the jaw members 30. At a location between the pivotally pinned mounting ends of the jaw members 30 and the concave recesses 30a thereof, a compression spring 36 is received between the two movable jaws to normally bias the recessed areas 30a of the jaw members toward one another. Accordingly, the jaw will normally occupy a closed position in which the inner sides of the two jaw members abut against one another to delimit a circular jaw space 38 between them at the two concavely recessed areas 30a.

A release mechanism for opening the jaw 28 features a manual release lever 40 fixed to an L-shaped link 42 that is made up of two L-shaped plates affixed to opposing sides of the release lever 40. The release lever 40 initially extends upright from the L-shaped link 42 in parallel relation to the upright leg 42a of the L-shaped link 42 at an upper end thereof that resides outside the housing 10 at a spaced distance above the cover plate 26. From here, the lever then curves forwardly and upwardly toward the front end of the hitch conversion unit, where the lever then turns upwardly again to form an upright handle grip 44. The upright leg 42a of the L-shaped link 42 reaches downwardly into the hollow interior of the housing 10 through an opening 46 in the cover plate 26, thereby placing the more horizontal lower leg 42b of the L-shaped link 42 inside the housing interior. The cover plate 26 features two upright lugs 48 standing perpendicularly upward therefrom at opposing sides of the opening 46, for example in the form of integrally bent portions of the cover plate. A horizontal pivot pin 50 passes through the release lever and L-shaped link 42 via aligned bores 52 in the upright lugs 48, and thereby pivotally couples the release lever 40 and attached L-shaped link to the upright lugs 48 to enable pivoting of the release lever and L-shaped link about the horizontal axis of the pivot pin 50.

Inside the housing, an intermediate link 54 of the release mechanism features a pair of matching bars whose forward ends are pivotally coupled to the rear end of the L-shaped link's lower leg 42b by another pivot pin 56, which lies parallel to the pivot pin 50 of the release lever 40. A single-bar output link 58 in turn has its forward end pivotally coupled to the rear end of the double-bar intermediate link 54 by pin 57. A washer 60 is slidably disposed on the output link 58 for sliding movement back and forth therealong. A coiled compression spring 61 spirals around the output link 58 with its forward end abutted against the rear face of the sliding washer 60.

Rigidly attached to the rear end of the output link is the closed end of a fork member 62. The closed end of the fork member is defined by a cross-bar 64 spanning horizontally and perpendicularly across the rear end of the output link 58. Two fingers 66 of the fork member 62 project rearwardly from the crossbar near opposing ends thereof. The fork member 62 embraces around the pivotally mounted ends of the jaw members 30 so that the two fingers 66 of the fork member 62 reside on opposite sides of the jaw 28 at exterior sides of the jaw members 30.

The fingers 66 of the fork member 62 having angled interior sides 66a that face together and converge toward one another in the forward direction moving toward the closed end of the fork at which they are joined together by the cross-bar 64. The converging angle of the interior sides 66a of the fork fingers 66 is best shown in the overhead plan view of FIG. 12. In a default state of the release mechanism, the internally recessed areas 30a of the jaw members 30 reside between the two fingers 66 of the fork 62, and the angled interior sides of the finger's abut against the outer sides of the jaw members to hold them together in the closed position. As shown in FIG. 12, the jaw 28 will automatically open when the fork 62 is retracted forwardly along the interior of the housing far enough so that the fingers 66 of the fork no longer hold the two jaw members 30 together. To accomplish such opening of the jaw under retraction of the fork, the operator of a tractor to which the three-point mounting arrangement of the conversion unit 10 is attached reaches back from the operator seat of the tractor, grasps the handle grip 44 of the release lever 40, and pushes the handle grip 44 rearwardly. This pivots the release lever 40 rearwardly about the pivot pin 50, which in turn draws the rear end of the L-shaped link's lower leg 42b forwardly. This pulls forwardly on the intermediate link 54, the output link 58, and the fork 62, and this movement of the fork allows the jaw 28 to open under the action of the jaw's compression spring 36.

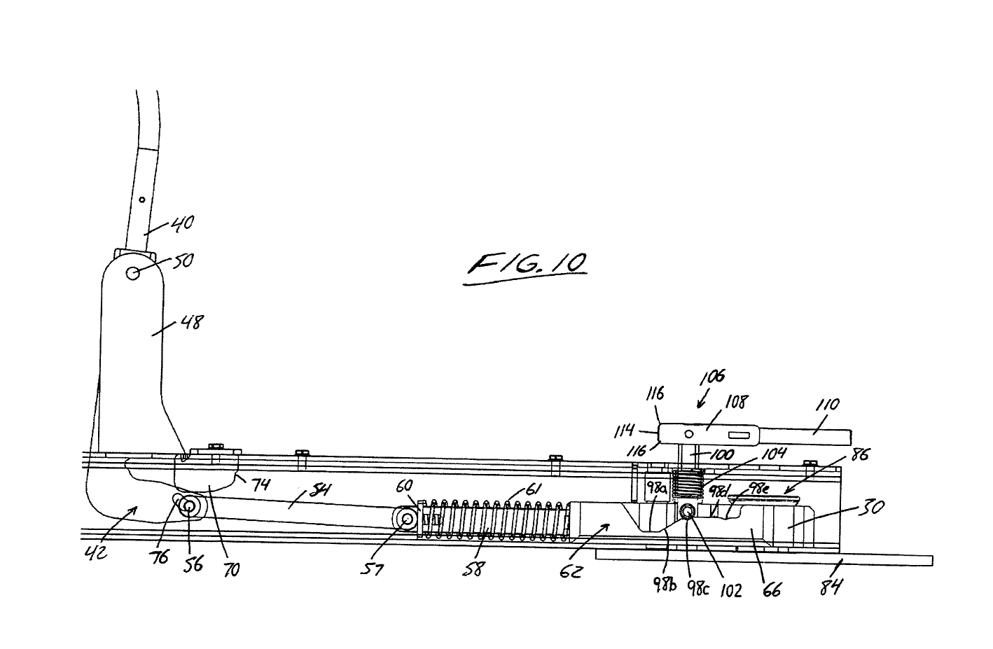

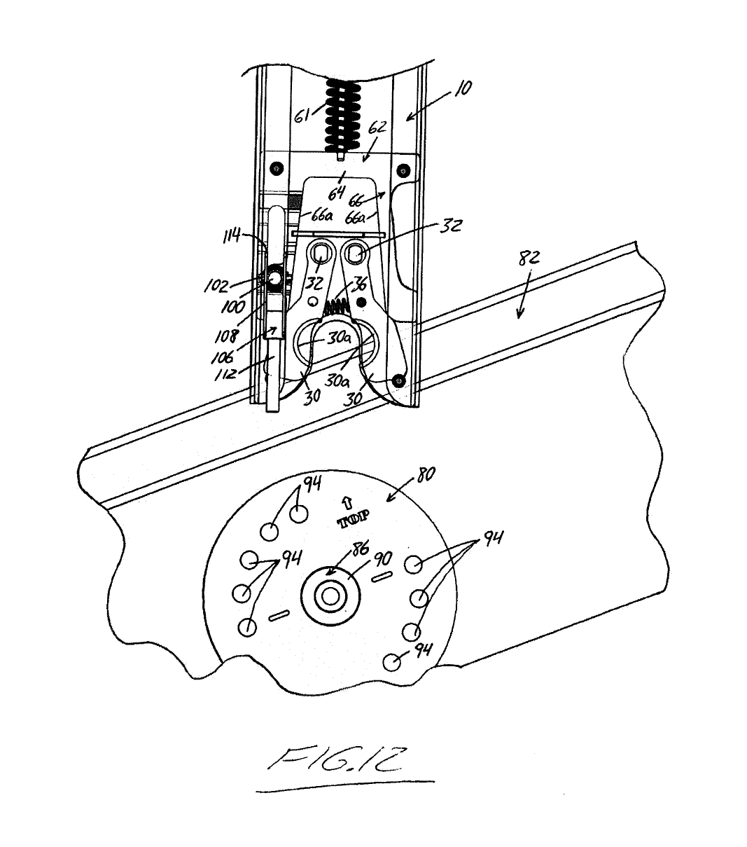

FIG. 8 shows the lever 40 and connected links 42, 54, 58 of the release mechanism in their normal default state holding the jaw 28 closed. To normally maintain this default state, a detent plate 70 hangs downward from the cover plate 26 through a slot 72 therein at the rear end of the opening 46, as best shown in FIGS. 5 and 10. The detent plate lies in a central vertical plane that cuts longitudinally through of the housing, and features a notch 74 in its rear end just above the lower rear corner of the plate 70. The notch 74 of the detent plate 70 is best seen in the close-up view of FIG. 10. Turning back to FIG. 8, it can be seen that in the default state of the release mechanism, the pivot pin 56 spanning between the two bars of the intermediate link 54 rests in the notch 74 at the rear end of the detent plate, and the compression spring 61 coiled around the output link 58 pushes forwardly against the slide washer 60, which in turn pushes forwardly against the bars of the intermediate link 54 at the rear ends thereof. Accordingly, the bars of the intermediate link 54, and thus pivot pin 56 spanning across these bars at the front end of the intermediate link, are urged forwardly, thus forcing the pivot pin 56 against the notch 74 of the detent plate 70. Therefore, the release mechanism will maintain this default state until the lever 40 is acted upon with sufficient force to overcome the spring force of the release mechanism's compression spring 61. To allow the pivot pin 56 to ride downwardly out of the detent notch 74 under sufficient input force on the lever, the hole through which the pivot pin 56 passes through the lower leg 42b of the L-shaped link near the rear end thereof has an angled slot-shape, as shown at 76 in FIG. 8. Accordingly, when the lever 40 is pushed rearward with sufficient force, the induced downward movement of the rear end of the L-shaped link's lower leg 42b pushes downwardly on pivot pin 56, which is allowed to ride rearwardly along the slot-shaped opening 76 and move downwardly over the lower rear corner of the detent plate 70, whereupon continued movement of the release mechanism in this releasing direction is allowed to continue, without resistance from the compression spring 61.

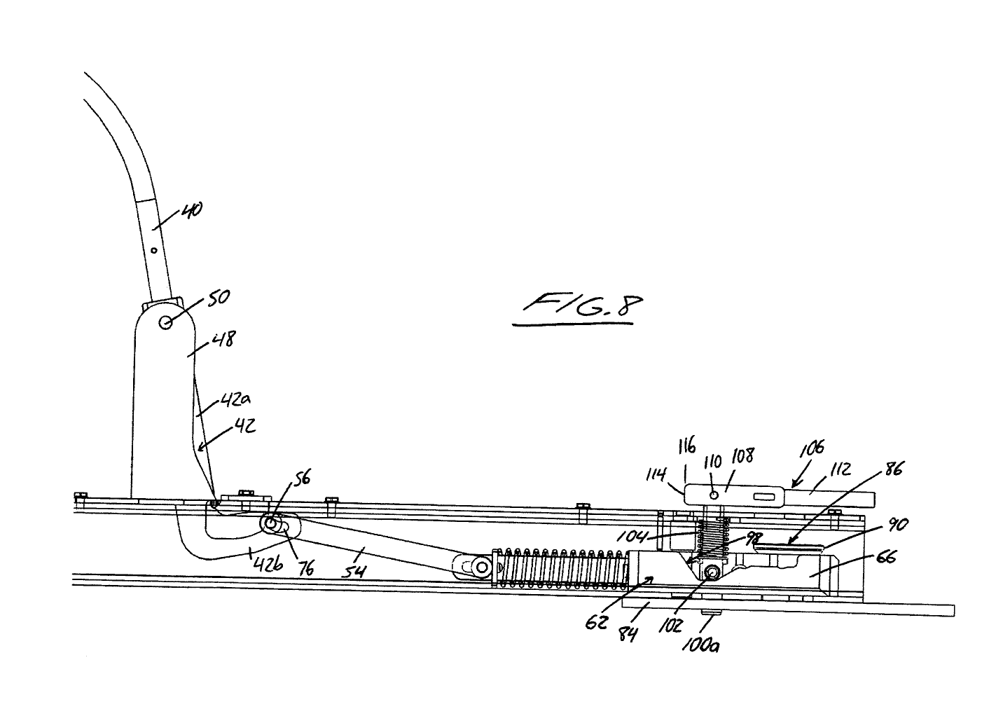

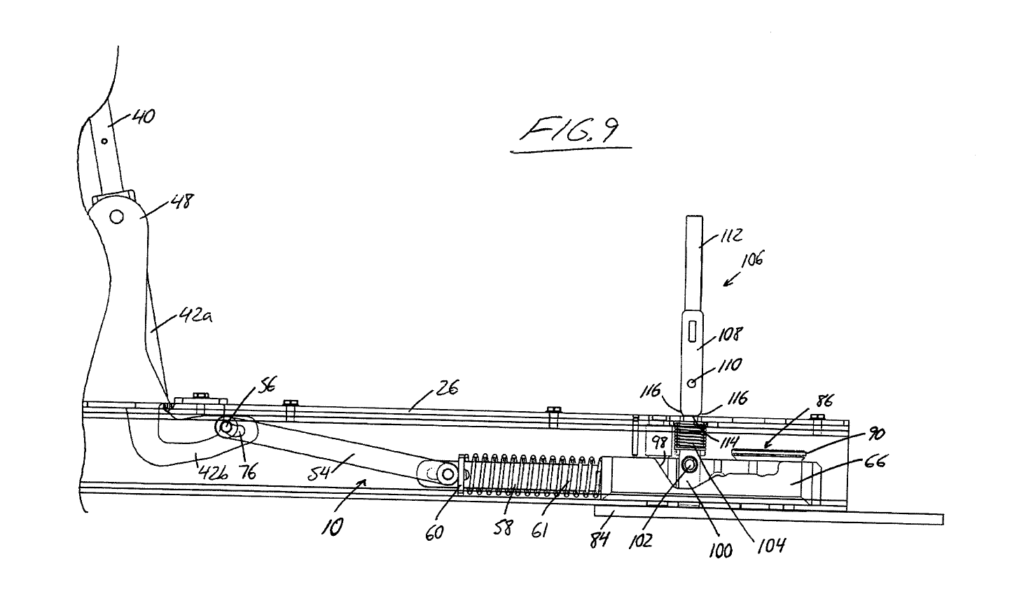

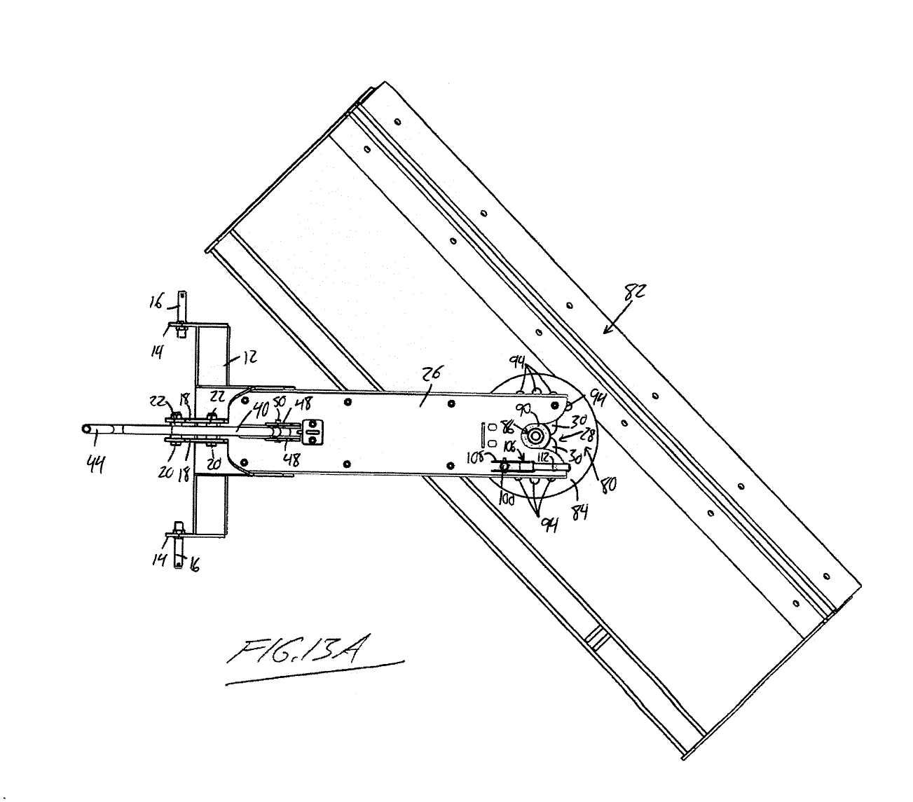

FIG. 5A shows a kingpin unit 80 that is mountable on an implement, for example on the box blade implement 82 shown in FIGS. 6 through 13. The kingpin unit 80 features a planar base plate 84, and a kingpin 86 standing perpendicularly upright from the topside of the base plate 84. The lower part of the kingpin 86 is defined by a cylindrical shank 88 of a first diameter, above which an enlarged head 90 of greater diameter forms an upper part of the kingpin. A frustoconical chamfer 92 provides a tapered transition from the smaller diameter shank to the enlarged head 90. A series of lock holes 94 pass perpendicularly through the base plate 84 from the topside thereof through to the parallel and opposing underside thereof. The lock holes 74 all reside at a common radial distance outward from the central axis of the upright kingpin shank 88, and are circumferentially spaced apart from one another around this central axis of the kingpin.

FIG. 6 schematically illustrates mounting of the kingpin unit on a box blade or other implement 82. The kingpin unit is mounted in a position atop a frame of the implement so that the kingpin stands perpendicularly upright therefrom. When the box blade implement 82 occupies a parked position seated flat atop a horizontal ground surface, the base plate of the kingpin unit occupies a horizontal position atop a frame member of the implement, and the kingpin stands vertically upright from the base plate and underlying implement frame. The diameter of the kingpin shank 88 is equal or slightly lesser than the diameter of the circular jaw space 38 delimited by the concavely recessed inners sides 30a of the jaw members 33 of the conversion unit when closed together. The diameter of the enlarged head of the shank is greater than this jaw space diameter. The axial height of the shank slightly exceeds an axial measurement through the jaw space 38 from the planar topside of either jaw member the planar underside of the housing's bottom wall. The bottom wall of the housing features a cut-out or void that underlies the jaw at the rear end of the housing to accommodate insertion of the kingpin into the jaw.

With the three-point mounting arrangement of the hitch conversion unit coupled to the three-point hitch of a tractor, successful mounting of the implement to the tractor requires only that the tractor operator push the lever 40 rearwardly to open the jaw 28, and reverse the tractor toward the implement until the open jaw of the hitch conversion unit embraces about the kingpin shank, thus providing a greatly simplified connection process versus a three-point connection. At this point, the jaw is then closed around the kingpin shank by pulling the lever 40 forwardly, which forces the rear end of the lower leg 42b of the L-shaped link rearwardly across the bottom of the detent plate 70, and then upwardly around the lower rear corner thereof, at which point the compression spring 61 once again forces pivot pin 56 into detent notch 74. This forward movement of the lower leg 42b of the L-shaped link drives the intermediate link and output link rearwardly, thus forcing the fork member rearwardly into action sliding contact with the outer sides of the jaw members, thus forcing the jaw closed. With the detent notch engaged by pivot pin 56, the release mechanism will lock the jaw in this closed position until such time as the release action is initiated by rearward pushing of the lever with sufficient force to overcome the holding action of the release mechanism's compression spring 61. In addition to biasing the pivot pin 56 into the detent notch to normally retain the closed condition of the jaw, the compression spring 61 also applies a continuous rearward force on the fork, which in turn applies continuous pressure on the sides of the jaw members to keep the inner sides of the jaw members tight to the kingpin when received in the jaw.

Accordingly, a user with multiple implements can simply perform a one-time, three-point connection of the hitch conversion unit to the tractor, and then can easily attach and detach any implements equipped with the compatible kingpin unit. The kingpin unit can be added to existing implements, or incorporated into fabrication of new implements.

During the implement attachment process, the taper of the frustoconical chamfer 92 on the kingpin cooperates with a matching taper of a corresponding frustoconical chamber 38a created at the top of the jaw space 38 by chamfered upper edges of the jaw members 30 at the recessed areas 30a thereof. Accordingly, if the jaw attempts to close around the kingpin at slightly too high an elevation thereon, the attempted closure of the tapered jaw members 30 around the chamfered area 92 of the kingpin will cause relative axial shifting between the jaw and kingpin to achieve proper alignment. This way, the axial depth of the jaw space can be sized to closely match the axial measurement of the kingpin shank to achieve a tight axial fit therebetween, thus drawing the implement up into abutment or tightly spaced proximity with the underside of the housing's bottom wall 10a to minimize play between the implement and the conversion unit, and thereby improve the stability of the implement on the tractor.

With reference to FIG. 5B, one of the two fingers 66 of the fork member 62 of the hitch conversion unit features a bifurcated portion with a slot-shaped hole 96 passing downwardly therethrough from a profiled topside of the finger to a planer underside thereof. The profiled topside defines a matching pair of profiled cam surfaces 98 on opposite sides of the slot-shaped hole 96. A lock pin 100 has an upper end disposed outside the housing above the cover plate 26, and reaches downward through a hole in the cover plate 26 of the housing into the slot-shaped hole 96 in the profiled finger of the fork member 62. A cross-pin spans diametrically through the lock pin inside the hollow interior of the housing in a direction lying across the profiled cam surfaces 98 of the profiled finger, and carries a pair of roller bearings on opposite sides of the lock pin 100 to form a cam follower 102. A compression spring 104 is coiled around the lock pin 100 inside the housing between the underside of the cover plate 26 and an exterior shoulder provided on the lock pin 100 at a location a short height above the cam follower 102. The compression spring 104 thus forces the bottom end 100a of the lock pin downwardly through the slot-shaped hole 96 in the profile finger of the fork member 62, and thereby urges the cam follower downwardly against the profiled cam surface 98. The cam follower thus rides along the profiled cam surfaces 98 during back and forth movement of the fork member 62 by the release lever 40.

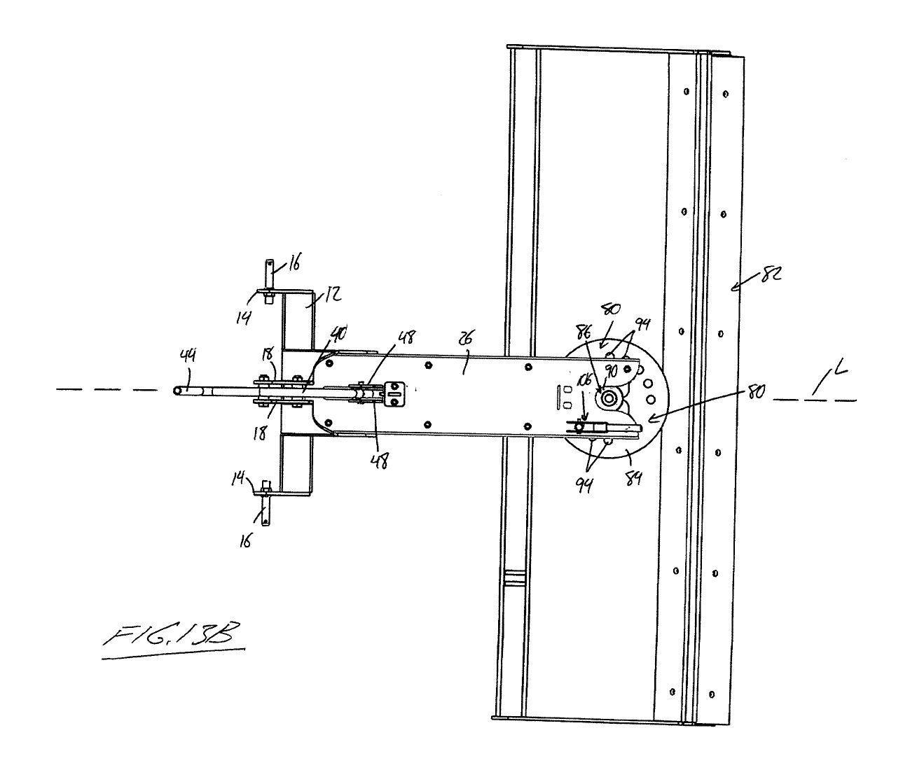

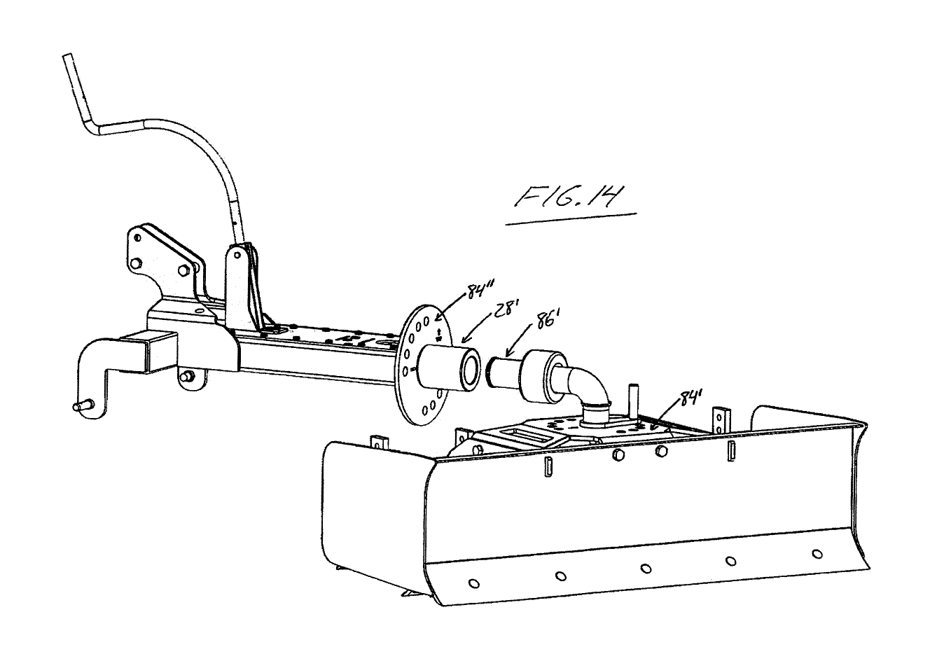

A low valley 98a exists at the forward ends of the cam surfaces, and this low valley aligns with the lock pin 100 in the default state of the release mechanism, as shown in FIG. 8. The radial distance from the central axis of the jaw space 38 to the center of the lock pin 100 is equal to the radial distance from the central axis of the kingpin shank 88 to the center of each locking hole of the kingpin base plate 84. When the implement is mounted to the hitch conversion device by engagement of the kingpin in the closed jaw, the central axes of the jaw space and the kingpin are coincident with another. The lock holes in the kingpin base plate are situated such that one of the lock holes 94 will align with the lock pin 100 when the implement 82 is mounted to the hitch conversion unit in a forward facing, normal orientation placing a width of the implement perpendicular to the longitudinal axis L (as shown in FIG. 13B). When the conversion unit is mounted to a tractor, the longitudinal axis of the conversion unit is coincident with a longitudinal travel direction of the tractor, whereby the longitudinal axis denotes a travel direction in which the conversion unit is conveyed during use. Unless the lock pin 100 is locked out (in a manner described herein further below), whenever one of the locking holes 94 in the kingpin base plate 84 aligns with the lock pin 100 of the conversion unit, the compression spring 104 coiled around the lock pin 100 will drive the bottom end 100a of the lock pin downwardly through the slot-shaped hole 96 in the profiled finger of the fork member 62, and onward through an aligned hole in the bottom wall 10a of the housing 10, into said aligned lock hole 94 of the kingpin base plate 84.

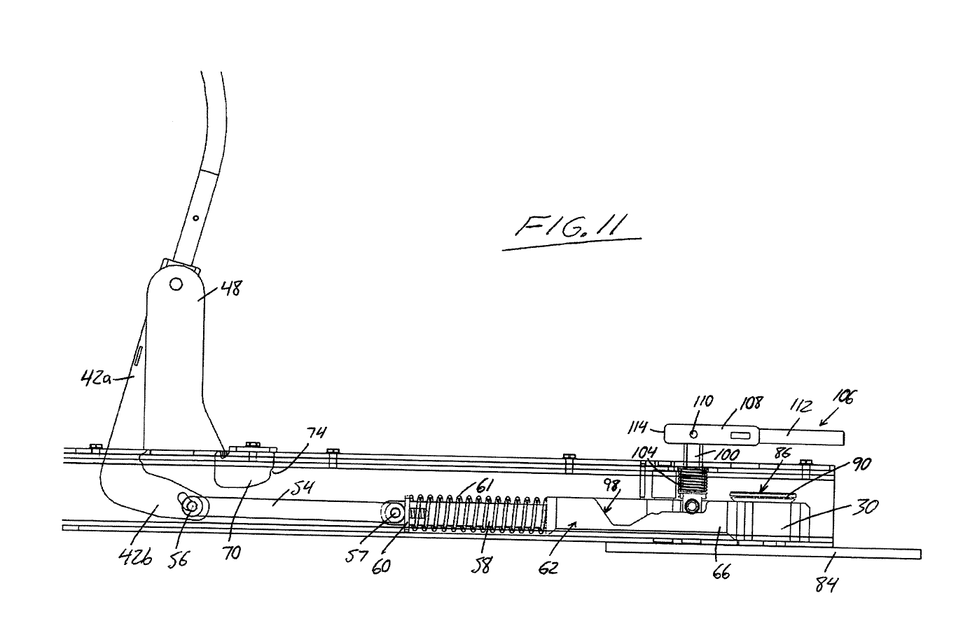

FIG. 8 shows the lock pin in its locking position reaching into one of the locking holes 94 of the kingpin base plate 84, but with the implement width in an obliquely angled orientation relative to the longitudinal axis L. Accordingly, each lock hole 94 in the kingpin base plate 84 corresponds to a different possible angular orientation of the implement 82 relative to the conversion unit and tractor. FIG. 9, by comparison, illustrates an unlocked position of the lock pin 100, where the lock pin 100 has been drawn upwardly to retract the lock pin's bottom end out from the kingpin base plate 84, thus freeing up the implement for rotation about the common upright axis shared by the kingpin 86 and the jaw space 38. This way, a user can swivel the implement about the shared axis into a new desired position aligning the lock pin 100 with another one of the lock holes 94 to change the working angle of the implement, at which point spring assisted return of the lock pin 100 to its locked position will lock the implement at this selected position by blocking relative rotation of the implement's kingpin 86 inside the hitch jaw 28.

On the other hand, the lock pin 100 is also provided with a lock out mechanism 106 by which the spring-biased deployment of the lock pin 100 into the locking position can be effectively locked out, thus allowing the implement to stay in a free-swiveling state, even during conveyance of the implement by the tractor. For this purpose, a lock out lever 108 is pivotally coupled to the lock pin 100 near the top end thereof by a cross-pin 110 passing diametrically therethrough. An operating end of the lock out lever 108 has a grip handle 112 thereon for manual operation of the lock out lever. By way of the grip handle 112, the lock out lever is pivotable between a normal position lying transversely across the lock pin 100, as shown in FIG. 8, and a lock out position lying axially parallel to the lock pin 100, as shown in FIG. 9. In the lock out position, a flat working end 114 of the lock out lever 108 opposite the grip handle 112 abuts against the topside of the housing's cover plate 26, which serves as a stop surface preventing the lock pin's compression spring 104 from forcing the lock pin 100 downwardly into the locking position. Curved corners 116 provide smooth gradual transition from the flat working end 114 of the lock lever to each of the longitudinal sides thereof. So, referring to FIG. 8, pulling up on the grip handle 112 of the lock out lever will allow the lock out lever to smoothly rock pivot about one of its curved corner transitions 116 toward the upright lock-out position of FIG. 9. Tilting the grip handle 112 in either direction out of its upright lock-out position will allow the lock pin's compression spring 104 to once again act in its intended manner forcing the lock pin 100 back downward toward its locking position.

From the forgoing, it will be appreciated that in order to fully release the implement's kingpin from the jaw, not only must the jaw be opened, but the lock pin must be retracted to its unlocking position of FIG. 9, or to an indexing position described below. The necessary lifting of the lock pin required to raise it up into the indexing position is performed by the cam surfaces 98 on the profiled finger of the fork member 62, whereby the same release mechanism for opening the jaw 28 doubles as a release mechanism for release of the angular position lock that otherwise prevents rotation of the implement relative to the tractor.

Moving rearwardly from the low valley 98a, the cam surfaces 98 first have an upwardly inclined slope 98b, at the top of which a small there is a small concave depression 98c, followed by a plateau 98d, and then a second small concave depression 98e. During retraction of the fork member 62 by rearward pushing of the release lever 40, the cam follower 102 of the lock pin 100 rides up the inclined slope 98b of the cam surfaces 98 and then settles in the first depression 98c. This represents a first stage of the release process, where the fork member 62 has not yet been withdrawn far enough forwardly to allow the spring-loaded jaw 28 to open, but the lock pin 100 has been lifted up into the indexing position substantially withdrawn from the lock hole 94 in the kingpin base plate 84. This substantial withdrawal of the lock pin 100 is differentiated from full withdrawal thereof that occurs in the full unlocking position of FIG. 9 by the fact that in the substantially withdrawn indexing position, a rounded terminus at the bottom end of the lock pin remains just inside the respective hole in the kingpin base plate 84, and acts as a detent to provide some resistance to rotation between the kingpin and the jaw. However, with application of a sufficient movement force attempting the rotate the implement about the kingpin, the rotation of the kingpin base plate will force this rounded terminus of the lock pin to ride up out of the hole in the kingpin base plate against the bias of the spring 104 and allow the implement to continue rotating until the lock pin reaches the next hole in the base plate, where spring 104 will force the pins rounded bottom end down into this next hole. The resistance to the implement rotation provided by this rounded bottom end of the pin helps the user index the implement from one selectable angle to the next, and provide a tactile feedback when proper alignment of the lock pin with the respective hole in the base plate occurs at each lockable angular position of the implement. The term “release position” is used herein to generally encompass both the full unlocking position of the locking pin (FIG. 9) that allows uninhibited free swiveling of the implement, and the indexing position of the locking pin (FIGS. 10 & 11) that allows indexed rotation of the implement.

Continued rearward pushing of the release lever 40 will move the linkage of the release mechanism further forward, pulling the fork member 62 further forwardly until the cam follower 102 crosses the plateau 98d and settles into the second depression 98e, at which point the jaw 28 is fully freed from the fork member and allowed to open, thereby releasing the kingpin 86. Accordingly, the shared release mechanism is operable to release both the lock pin 100 and the jaw 28 to enable detachment of the implement. Connection and disconnection of the implement can thus be performed entirely from the operating seat of the tractor using one lever, thereby avoiding the need for two different release controls, or the need for a second person to release the lock pin 100 using the lock-out mechanism 106 located further back on the unit. Like at the first depression, the cam follower's settled position in the second depression places the lock pin 100 in its indexing position.

By placing the kingpin unit atop the implement such that the implement hangs downward from the jaw that closes around the shank of the kingpin beneath the enlarged head, the implement can swivel a full 360-degrees around the shared axis of the kingpin and hitch jaw, thereby providing maximum adjustability when switching between selected static working angles, and also allowing use of the implement in a dynamic-angle free-swiveling state.

While the illustrated embodiment shows a box blade implement as an example of a mounted implement lacking any ground wheels and relying solely on the tractor and conversion unit to bear the full weight of the implement when raised up into a transport position through operation of the three point hitch of the tractor, it will be appreciated that any other mounted implement may likewise be equipped with a kingpin unit of the type described herein to enable quick and easy attachment and detachment, and also allow angular adjustment and free-swiveling use. While the angular-adjustment and swivel-enabling arrangement of the illustrated embodiment places the lock holes on the implement and the lock pin on the hitch conversion unit, it will be appreciated that this configuration may be reversed. However, the placement of the lock pin on the hitch conversion unit is believe to be advantageous in terms of enabling use of the shared release mechanism to operate both the jaws and the lock pin, and in terms of not duplicating the more complex lock pin on multiple implements intended for use with the conversion unit. While the illustrated embodiment uses a jaw with two movable jaw members, other embodiments may employ a jaw design with a single moving jaw. While a jaw and cooperating kingpin are used as a preferred example of a single-point coupler on the conversion unit and cooperating single-point connector on the implement for simple mating of the implement to the conversion unit at a singular point of connection, other single-point connection components may alternatively be employed.

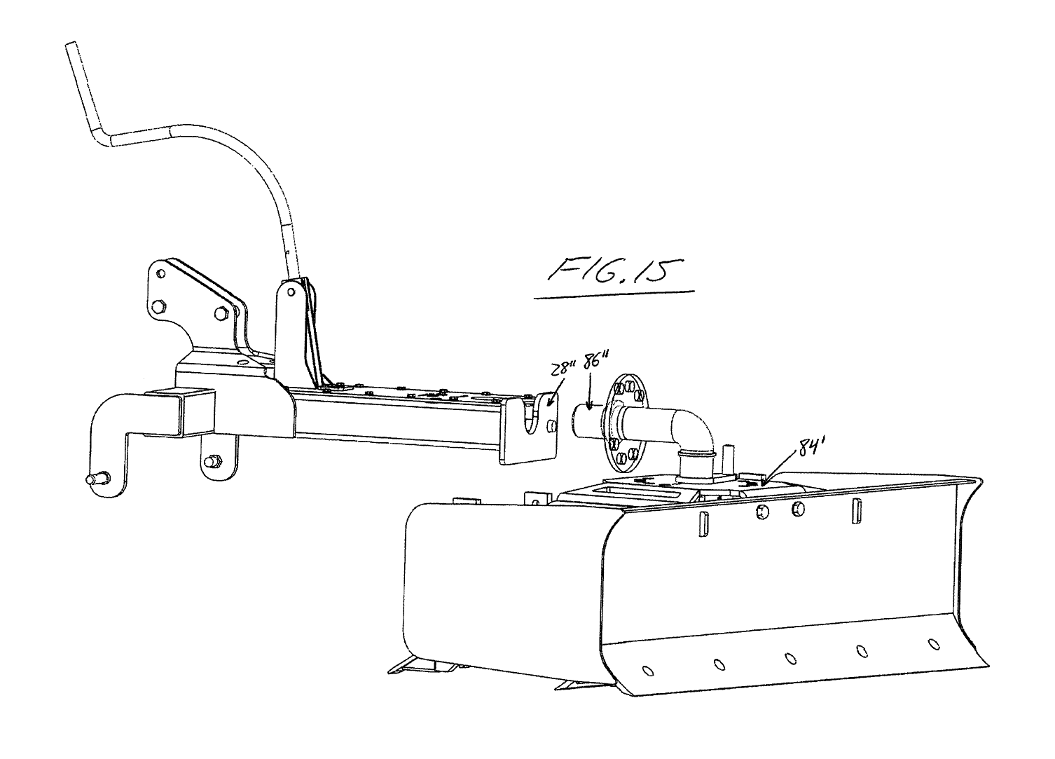

For example, FIG. 14 illustrates an embodiment where a male connector 86′ on the implement replaces the kingpin of the other embodiments and is inserted into a male coupler 28′ on the conversion unit that replaces the hitch jaw of the other embodiments. The male connector is inserted and withdrawn to and from the mating female coupler along the longitudinal axis L of the conversion unit. The male connector 86′ is carried by an elbow shaped neck reaching initially upright from the topside of the implement and then turning forwardly toward the conversion unit and the tractor (not shown) carrying same. The neck stands upright from an indexing plate 84′ that is fixed atop the implement and rotatable about the bottom end of the neck and has the same structure of the kingpin base plate of the earlier embodiments. This rotation of the index plate and attached implement about the upright bottom end of the neck provides the same angular adjustment and/or swiveling of the implement about an upright axis as described above for the earlier embodiments. The implement may also be allowed to tilt about the longitudinal axis L of the conversion unit via rotation of the male connector inside the female coupler, in which case a second index plate 84″ may be affixed to the conversion unit in an upright orientation spanning around the longitudinal axis L outward from the female coupler to receive a lock pin for selectively fixing the tilt angle of the implement about the longitudinal axis. This demonstrates that the angular adjustability and free-swiveling action of the implement enabled by the conversion unit need not be only about an upright axis, as in this instance, the angular change of the implement occurs about a longitudinal axis of the single-point connection between the implement and conversion unit. The use of two swivel points and two indexing plates thus allows angular adjustment and free swiveling about two axes, one providing a yaw movement about an upright axis and the other providing a roll action about a longitudinal axis.

FIG. 15 shows another example with roll-type angular adjustment or swiveling about a longitudinal axis and yaw-type angular adjustment or swiveling about an upright axis, similarly using a bent neck of the implement to lie on these two axes. In this example, the forward end of the neck defines a longitudinally oriented (rather than upright) kingpin 86″ that mates with an upright jaw 28″. So the jaw closes around the longitudinal kingpin in an upright plane at the rear end of the conversion unit, and the implement can tilt about the longitudinal axis L that passes centrally through the upright jaw and coincides with the axis of the longitudinal kingpin 86″. The implement can also be swiveled about the upright axis of the upright rear half of the elbow-shaped neck, whose bottom end is rotationally engaged with index plate 84′ in the same manner as the FIG. 14 embodiment. This demonstrates that even where a jaw and kingpin connection is employed between the conversion unit and implement, the shared axis of these components when mated need not necessarily be an upright axis, even when defining an axis about which the implement can be angularly adjusted or swiveled.

It will also be appreciated that the unique configuration of an angular-adjustment/swiveling arrangement that uses the axis of a kingpin hitch connection as the swivel point may be employed regardless of whether the jaw of the kingpin connection is part of an add-on hitch conversion unit like the illustrated embodiment, or part of an integral hitch device of a tractor or other working machine. Additionally, while the illustrated embodiment features a three-point mounting arrangement for connection to the three point hitch of a tractor, other embodiments could substitute another type of mounting arrangement for compatibility with working machines of other hitch or attachment types. In one example, the three-point mounting arrangement could be replaced by a skid steer quick-attachment arrangement or other loader attachment arrangement, enabling kingpin-equipped implements to be mounted to the lift arms of a skid steer or other loader-type working machine. Likewise, the three-point mounting arrangement could be replaced by an ATV or UTV attachment arrangement enabling kingpin-equipped implements to be mounted to the lift arms of an all-terrain vehicle or utility task vehicle.

Other applications include automotive applications, where multi-point vehicle mounts used to mount snow plows, powered sweepers or other implements to the front of a pickup or heavy duty truck can be converted to single-point attachment by the conversion unit, and lawn and gardent applications, where the conversion unit can be used to convenient single-point attachment of detachable mowers or other accessories on stand up or sit down zero turn mowers, or other ride-on lawn or yard equipment. In the present application, the term working machine is therefore used to encompass tractors, skid steers, loaders, ATVs, UTVs, trucks, mowers, and other vehicles with means for attaching working implements.

The term multi-point is used to designate an attachment arrangement where multiple points of two pieces of equipment are directly connected to one another at multiple points, and is not limited specifically to only two-point and three-point tractor hitches. So while the illustrated example converts a three-point attachment configuration (three-point hitch) of a tractor so a single-point jaw and kingpin configuration, other multi-point hitch/attachment types could likewise be converted to a single point using a conversion unit of the present invention.

While the illustrated embodiment employs a manual release lever 40 and associated linkage for operating the fork member that controls the jaw and lock pin, other embodiments may employ a powered actuator, e.g. hydraulic actuator, electric linear actuator, electric motor, etc. to displace the fork member back and forth to open and close the jaw.

Since various modifications can be made in my invention as herein above described, and many apparently widely different embodiments of same made, it is intended that all matter contained in the accompanying specification shall be interpreted as illustrative only and not in a limiting sense.

1. In combination, a mounted implement for a working machine and a conversion unit for indirect attachment of said mounted implement to said working machine in a mounted position fully supported by said working machine, wherein said mounted implement comprises a single-point connector thereon, and said conversion unit comprises a multi-point mounting arrangement configured for removable coupling to a multi-point attachment arrangement on the working machine and a single-point coupler configured for removable coupling to the single-point connector, whereby with the conversion unit in an operating position attached to the attachment arrangement of the working machine, coupling of the mounted implement to the conversion unit via engagement of the single-point coupler with the single-point connector indirectly attaches the mounted implement to the working machine for support in the mounted position.

2. The combination of claim 1 wherein the single-point coupler of the conversion unit comprises a hitch jaw closable about a jaw space, and the single-point connector on the mounting implement is a kingpin that stands upright therefrom for receipt of the kingpin in the jaw space with the jaw closed therearound for hanging support of the mounted implement below the hitch jaw in the mounted position of the implement.

3. The combination of claim 2 wherein the kingpin comprises a shank of lesser or equal diameter than a jaw space delimited by the hitch jaw in a closed state thereof, an enlargement of greater diameter than said jaw space such that said enlargement blocks axial withdrawal of the kingpin from said hitch jaw in the closed state thereof, and a taper between said shank and said enlargement that matches a corresponding taper on the hitch jaw.

4. The combination of claim 3 wherein the enlargement of the kingpin resides above the shank.

5. The combination of claim 1 comprising a set of lock holes disposed circumferentially around the single-point connector or the single-point coupler on a first one of either the conversion unit or the mounted implement, and a lock pin disposed on a different second one of either the conversion unit or the mounted implement, said lock pin being movable between a locked position engaged in any selected one of said lock holes to block rotation of the mounted implemented relative to said conversion unit about a shared upright axis of said single-point connector and the single-point coupler when said single-point connector and the single-point coupler are engaged, and unlocked released position at least substantially withdrawn from said lock holes to allow said rotation of the mounted implement about said shared axis.

6. The combination of claim 5 wherein said lock holes are located on said mounting implement, and said lock pin is disposed on said conversion unit.

7. The combination of claim 5 wherein said lock pin is biased into the locking position.

8. The combination of claim 7 comprising a lock-out mechanism switchable between a lock-out state fully withdrawing the lock pin from the selected one of the lock holes and preventing biased deployment of the lock pin into the locking position to allow free-swiveling of the mounted implement about the shared axis, and a normal state allowing biased deployment of the lock pin into the locking position.

9. The combination of claim 8 wherein the lock-out mechanism comprises a lock-out lever that has an operating end and an opposing working end, is pivotally coupled to the lock pin for movement about a pivot axis transverse thereto, and is movable between a lock-out position lying axially of the lock pin with the working end abutted against a stop surface blocking axial displacement of the lock pin, and a normal position lying transversely of the lock pin with the working end withdrawn from contact with the stop surface.

10. The combination of claim 5 wherein the lock holes are defined in a base plate of the single-point connector on the implement.

11. The combination of claim 5 comprising a shared release mechanism operable to both release the single-point coupler and withdraw the lock pin from the locked position into the released position.

12. The combination of claim 11 wherein the single-point coupler of the conversion unit comprises a hitch jaw, the hitch jaw comprises a pair of jaw members pivotal toward and away from one another for closing and opening of the hitch jaw, and the shared release mechanism comprises a fork that has two fingers disposed on opposite sides of said hitch jaw at exterior sides of said jaw members and is displaceable back and forth between a jaw-closing position acting against the exterior sides of the jaws to hold the hitch jaw closed and jaw-releasing position allowing said jaw members to open away from one another, and a cam carried with said fork for back and forth movement therewith and over which a follower of the lock pin rides during said back and forth movement to transition said lock pin between the locked and released positions.

13. The combination of claim 12 wherein said cam resides on said fork.

14. The combination of claim 1 wherein the single-point coupler of the conversion unit comprises a hitch jaw, the hitch jaw comprises a pair of jaw members pivotal toward and away from one another for closing and opening of the hitch jaw, and a release mechanism of said hitch jaw comprises a fork that has two fingers disposed on opposite sides of said hitch jaw at exterior sides of said jaw members and is displaceable back and forth between a jaw-closing position acting against the exterior sides of the jaws to hold the hitch jaw closed and jaw-releasing position allowing said jaw members to open away from one another.

15. The combination of claim 12 wherein the fingers of the fork have angled interior sides that face one another, ride along the exterior sides of the jaw members, and converge toward a closed end of said fork at which said fingers are joined together so that movement of said closed end of said fork toward the hitch jaw gradually forces the jaw members toward one another into the closed state of the hitch jaw.

16. The combination of claim 1 wherein the multi-point mounting arrangement on the conversion unit is a three-point arrangement comprising two lower connect points for connection to two lower links of a three-point hitch on the working machine, and an upper connection point for connection to an upper actuator of the of the three point hitch.

17. The combination of claim 1 in further combination with the working machine, wherein the multi-point attachment arrangement of the working machine comprises a three point hitch at a rear end of said working machine, the multi-point mounting arrangement of the conversion unit is coupled to the multi-point attachment arrangement of the working machine in the operating position, and the mounted implement is attached to the conversion unit in the mounted position and is supported entirely by the working machine and the conversion unit.

18. The combination of claim 1 in further combination with the working machine, wherein the multi-point mounting arrangement of the conversion unit is coupled to the multi-point attachment arrangement of the working machine in the operating position, and the mounted implement is attached to the conversion unit in the mounted position and is supported entirely by the working machine and the conversion unit.

19. In combination, a mounted implement for a working machine and a hitch device for attachment of said mounted implement to said working machine, said hitch device and said mounted implement respectively having a single-point coupler and a cooperating single-point connector, axes of which coincide to define a shared upright axis when said single-point coupler and said single-point connector are connected together, wherein a set of lock holes are disposed circumferentially around the single-point coupler or said single-point connector, and a lock pin is movable between a locked position engaged in any selected one of said lock holes to block rotation of the mounted implemented relative to said hitch device about the shared upright axis when said single-point coupler and said single-point connector are connected, and released position at least substantially withdrawn from said lock holes to allow said rotation of the mounted implement relative to the hitch device about said shared axis.

20. A method of mounting an implement to a working machine, said method comprising:
on an existing mounted implement having a first multi-point mounting arrangement configured for attachment to an existing attachment arrangement on the working machine, installing a single-point connector;
with a conversion unit having both a single-point coupler and a second multi-point mounting arrangement that is compatible with said existing multi-point attachment arrangement of the working machine, attaching said conversion unit to the working machine by coupling second multi-point mounting arrangement on the conversion unit with said existing multi-point attachment arrangement of the working machine; and
coupling the single-point connector on the mounted implement to the single-point coupler of the conversion unit to thereby attach said mounted implement to the working machine, and supporting the mounted implement entirely by said conversion unit and said working machine.
